(19) United States
(12) Patent Application Publication
(10) Pub. No.: US 2006/0201298 A1
(43) Pub. Date: Sep. 14, 2006

(54) Mitre gauge & stock-guiding fence

(76) Inventor: Darrin Eugene Smith, Barrie (CA)

Correspondence Address: BIRCH STEWART KOLASCH & BIRCH, PO BOX 747, FALLS CHURCH, VA, 22040-0747, US

(21) Appl. No.: 11/370,832

(22) Filed: Mar. 9, 2006

(30) Foreign Application Priority Data
Mar. 10, 2005 (CA) 2,500,495

(51) Int. Cl. B26D 7/02

(52) U.S. Cl. 83/468

(57) ABSTRACT

The mitre gauge has lower, central and upper plates. The central plate is attached to a tool such as a fence and is pivotally attached to the lower plate while the upper plate is pivotally attached to the central plate. A pin selectively immobilizes the upper plate at a first set of stop points on the central plate but allows movement of the central plate relative to the lower plate. A second pin selectively immobilizes the upper plate at a second set of stop points on the lower plate but allows movement of the central plate relative to the lower and upper plates. The stop points are arranged such that at each stop point in the second set, the orientation of the central plate relative to the lower plate is restricted to a small number of predetermined positions. At each stop point in the first set, the central plate is immobilized at a single predetermined orientation. The fence is made up of terminal and main segments movable toward and away each other Sliding scales are provided on both segments. Depending on the length of a work piece, one or the other of the scales indicates its length.

### FIELD OF THE INVENTION

This invention relates to a fence for guiding a piece of stock or work on a workbench. The invention also relates to a mitre gauge which is particularly useful for locating a fence so that a cut of a required angle can be made in a piece of work.

### BACKGROUND OF THE INVENTION

The orientation or angle of a fence used for guiding a piece of stock on a workbench is usually adjusted by means of a mitre gauge. A scale is etched on one component of the gauge and the component is moved relative to a fixed component until the angle displayed on the scale is the required one. The movable component is secured against further movement by tightening a threaded portion of the component to the threads of the fixed component. Over time, the threads begin to wear and precise adjustment of the angle of the fence is no longer possible.

The mitre gauge of the invention has provision for locating a fence at a predetermined angle and securing the fence at that angle without the necessity of tightening one component of the gauge to another. There is accordingly little possibility that the angle will alter over time as a result of slippage between components of the gauge.

The fence of the invention has one or both of the following features: (a) provision for extending its effective length so the a piece of stock having a length greater than the effective length of the fence can be measured; and (b) a bar which fits into a groove in the working surface of a workbench for securing the fence to the workbench. The bar has provision for adjusting its effective width so that it fits into grooves of various widths.

### SUMMARY OF THE INVENTION

Briefly the mitre gauge of the invention includes: an adjusting element; a central element having means for moving in conjunction with a tool; first angle-adjusting means for selectively immobilizing the adjusting element at successive first stop points relative to the central element; and second angle-adjusting means for selectively immobilizing the adjusting element at successive second stop points relative to the working surface. The first and second stop points are arranged such that at each second stop point, the orientation of the central element on the working surface is confined to a restricted range, and at each first stop point, the central element is immobilized at a single orientation within the range.

Briefly the fence of the invention comprises an elongated member having terminal and main segments. The segments are adapted to move selectively apart and toward each other. A scale is displayed on the main segment and its position is adjustable to reflect its distance from a first reference position such as a saw blade. An indicator is movable in conjunction with the terminal segment and its position is adjustable to reflect its distance from the first reference position. The indicator has a wall which defines a second reference position. A pointer is movable in conjunction with the terminal segment and travels along the scale at such time as the terminal segment moves relative to the main segment. The scale is calibrated such that the reading indicated by the pointer represents the distance between the first and second reference positions.

### DESCRIPTION OF THE DRAWINGS

The mitre gauge and fence of my invention are described with reference to the accompanying drawings in which:

FIG. 1 is a perspective view of the fence in conjunction with a mitre gauge;

FIG. 2 is a perspective view of the fence, mitre gauge, guide bar and the rotary blade of a table saw;

FIG. 3 is an exploded perspective view of the mitre gauge;

FIG. 3A is another exploded perspective view of the mitre gauge;

FIG. 4 is a plan view of the central element of the mitre gauge;

FIG. 5 is a plan view of the upper element of the mitre gauge;

FIG. 6 is a plan view of the mitre gauge and a portion of the fence;

FIG. 7 is another plan view of the mitre gauge, and portions of the fence and guide bar;

FIG. 8 is a further plan view of the mitre gauge and a portion of the fence;

FIG. 9 is an elevation of a larger locating pin and a portion of the mitre gauge;

FIG. 10 is an elevation of mitre gauge and the locating pin removed therefrom;

FIGS. 11 and 12 are elevations of a smaller locating pin and portions of the mitre gauge. In FIG. 11 the smaller locating pin is removed from the gauge and in FIG. 12, the locating pin is connected to the gauge;

FIG. 13 is an elevation of the mitre gauge and terminal and main segments of the fence disposed adjacent to one another;

FIG. 14 is an elevation similar to FIG. 13 except that the terminal segment of the fence is spaced apart from the main segment;

FIG. 15 is an exploded perspective view of the terminal segment of the fence and a portion of the main segment;

FIG. 16 is an exploded perspective view of the main segment of the fence;

FIG. 17 is a plan view of the lower plate of the mitre gauge;

FIG. 18 is a plan view of a portion of a ruler on the upper wall of the fence;

FIG. 19 is an exploded perspective view of a portion of the guide bar;

FIG. 20 is a plan view, partly cut away, of the guide bar;

FIGS. 21-23 are cross-sections of the guide bar showing the way in which the effective width of the bar can be adjusted.

Like reference characters refer to like parts throughout the description of the drawings.

### Mitre Gauge

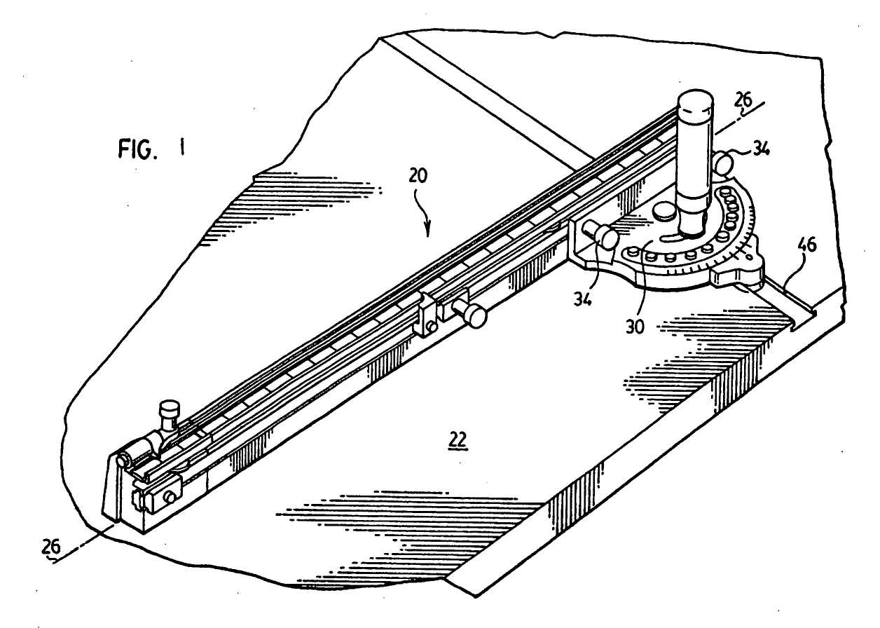

With reference to FIGS. 1-3, a fence, generally 20, is movable across the working surface 22 of a conventional table saw (not illustrated). The saw is mounted beneath the working surface of the table and its rotary blade 24 projects upwardly through a slot in its working surface.

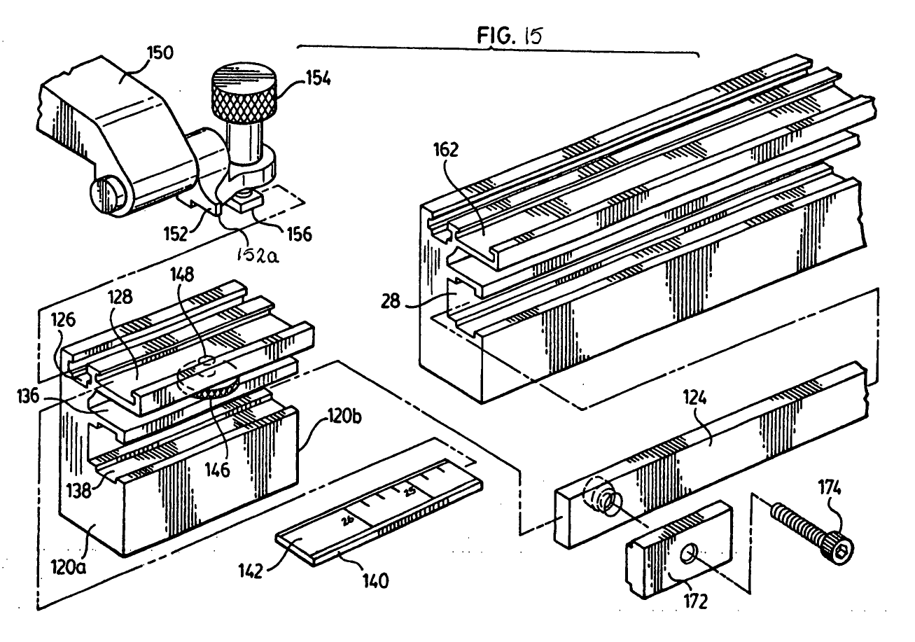

The fence has a longitudinal axis 26-26 along which a groove or T-slot 28 extends. The T-slot is shown in FIG. 16. A mitre gauge 30 is attached to the fence by means of a flat sliding bar 32 which moves in the groove and is connected to the gauge by means of a pair of threaded studs 33 which are threadably connected to the bar and which project outwardly of the T-slot and into openings in the gauge. Knobs 34 at the outer ends of the studs facilitate manual rotation thereof. When the studs are rotated to tighten them, the bar moves into engagement with the inner wall of the T-slot with resulting immobilization of the fence on the gauge.

With reference to FIGS. 1, 3 and 4, the mitre gauge has a central element or plate 36 which is pivotally attached to an elongated guide bar 38 by means of a stud 40 which projects through openings in the central plate and the guide bar. The stud is internally threaded and is held in position by means of a machine screw 42. The central plate rotates about axis 44-44 and henceforth this axis will be referred to as the “main axis” of the mitre gauge

The guide bar is slidable in a groove 46 in the working surface of the workbench. The mitre gauge is accordingly pivotal with respect to the working surface as is the fence which is secured to the gauge.

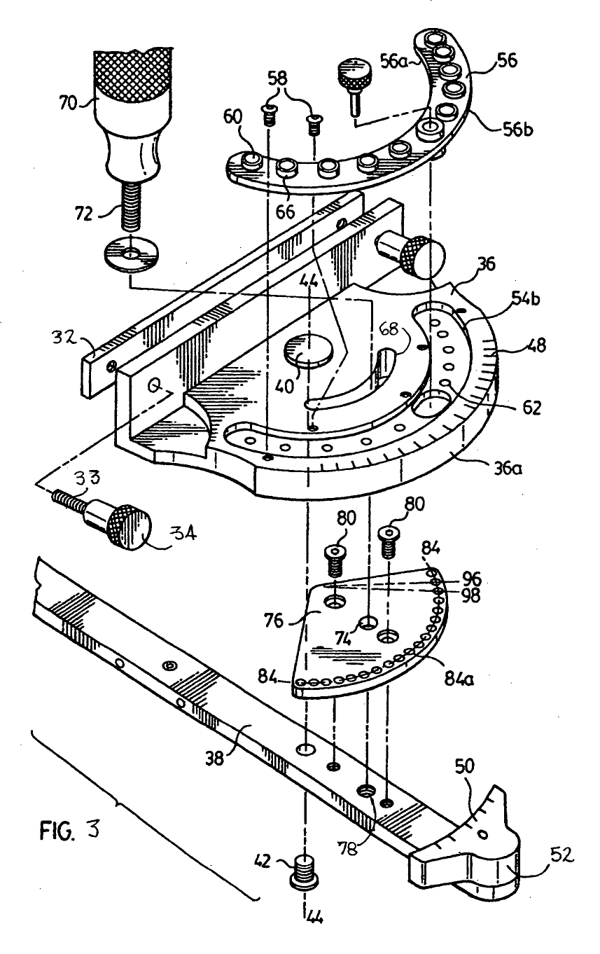

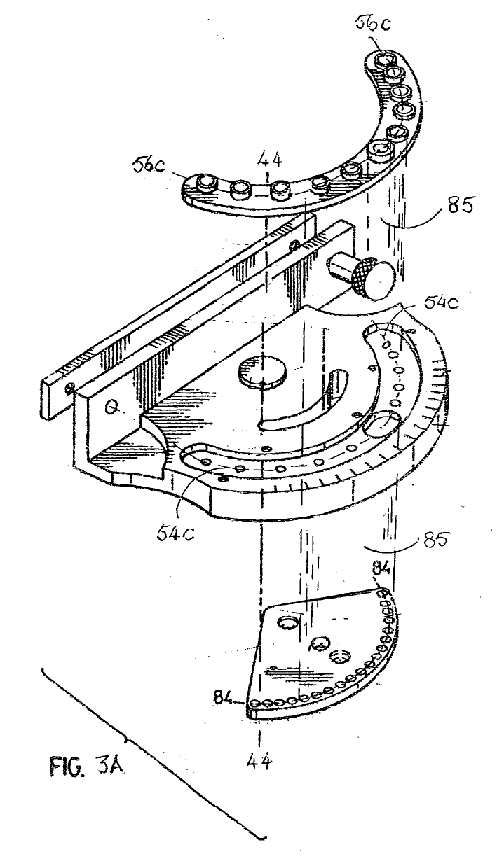

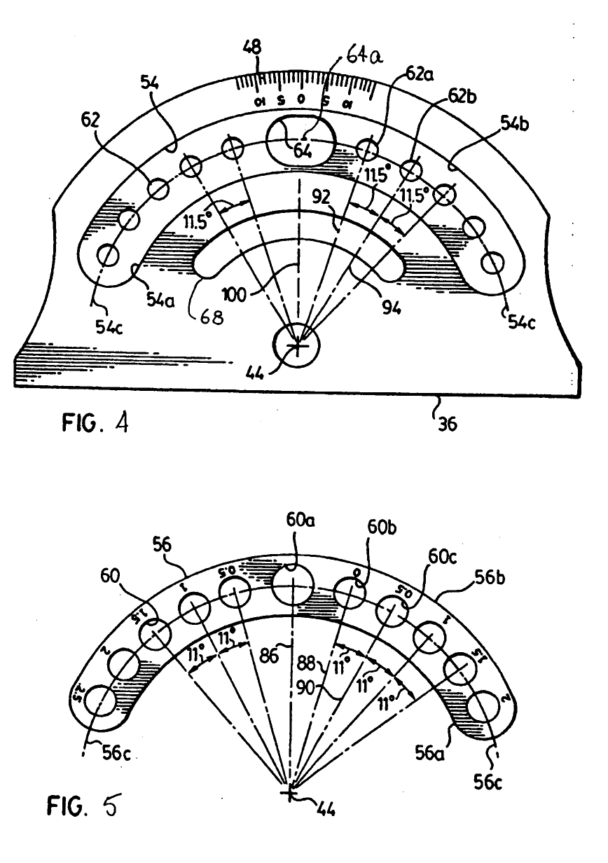

The outer edge 36a of the central plate is curved and is part of the circumference of a circle having its centre on the main axis of the mitre gauge. A scale 48 is etched or painted on the upper surface of the plate adjacent to the curved edge. Each line of the scale represents one degree of rotation from a central line identified zero (“0”) in FIG. 4. In FIG. 3, a second scale 50 is formed on a block 52 attached to the end of guide bar 38 and that scale also has a centre line identified as zero. The former scale is movable while the latter is stationary relative to the former scale thus the two scales cooperate to display the orientation of the mitre gauge relative to the guide bar. The angle so displayed is henceforth referred to as the “angle of the mitre gauge”.

With reference to FIGS. 3, 4 and 5, an arcuate groove 54 is formed in the central plate. Within the groove an arcuate adjusting element or upper plate 56 is received. The inner and outer walls 56a,b of the upper plate as well as its longitudinal axis 56c-56c are all in the shape of an arc of a circle having its centre on the main axis of the mitre gauge. Likewise the inner and outer walls 54a,b of the groove as well as its longitudinal axis 54c-54c are all in the shape of an arc of a circle having its centre on the main axis.

The length of the upper plate measured circumferentially on its axis 56c-56c is less than the length of the groove measured circumferentially on its axis 54c-54c. The upper plate may accordingly slide circumferentially in the groove. Lateral movement of the upper plate in the groove is however restricted. Such movement is possible because there is a slight gap between the inner and outer walls of the upper plate. That gap allows the upper plate from to slide without binding in the groove but the gap is not large to permit any more than slight lateral movement of the upper plate in the grove.

The upper plate is confined in the groove by means of screws 58 which are received in openings in the central plate.

A number of circular apertures 60 is formed in the upper plate. Except for the central apeture 60a, all apertures have the same radius and their centres are located on the longitudinal axis 56c-56c of the plate. In like manner, a number of circular apertures 62, all of the same radius except for the central aperture 64, is formed in the groove and their centres extend along the longitudinal axis 54c-54c of the groove. The central aperture 64 is in the shape of a slot.

When the upper plate is within the groove, its longitudinal axis 56c-56c lies on the vertically upward projection of the axis 54c-54c of the groove. In other words, axes 54c-54c and 56c-56c lie on a curved surface which is parallel to the main axis of the mitre gauge. As a result, as the upper plate slides in the groove, the position of each of its apertures will come into register or axial alignment with the position of successive apertures in the groove. Apart from the central apertures, the radii of the apertures in both upper and central plates are the same.

As illustrated in FIG. 3, a guide bushing 66 is received in each aperture in the upper plate to protect the side walls of the apertures.

An inner arcuate groove 68 is formed in the central plate and is spaced radially inward from groove 54. The inner and outer walls of the inner groove are like those of groove 54 in the shape of an arc of a circle having its centre on the main axis of the mitre gauge.

A handle 70 has, at its lower end, a threaded stem 72 which passes through the inner groove and into a threaded opening 74 in a positioning element or lower plate 76 and through a threaded opening 78 in the guide bar 38. The handle serves as means for releasably clamping the central plate to the guide bar to selectively prevent the central plate from rotating relative to the guide bar. Thus by means of the handle, the fence may be clamped in a fixed angular position relative to the working surface of the workbench.

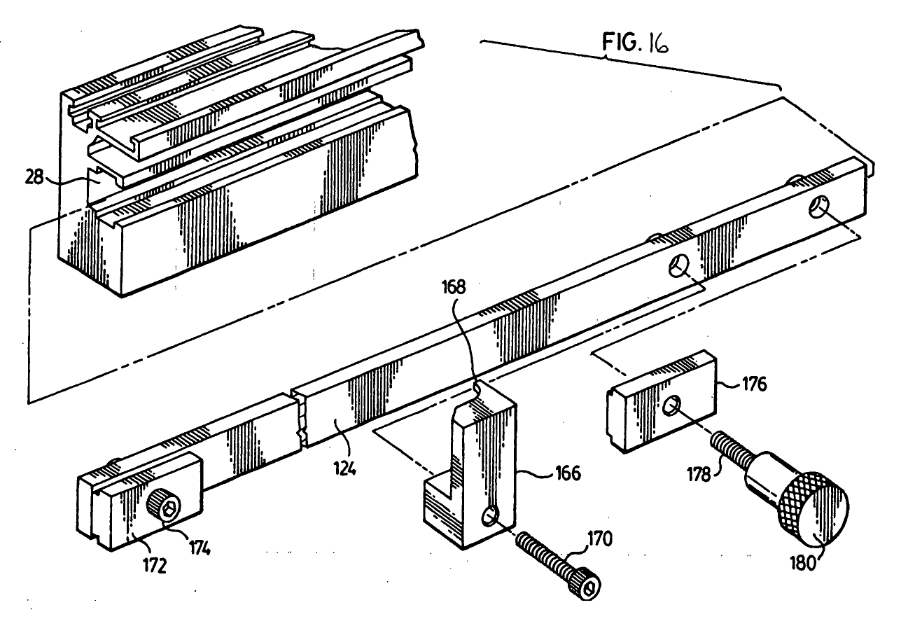

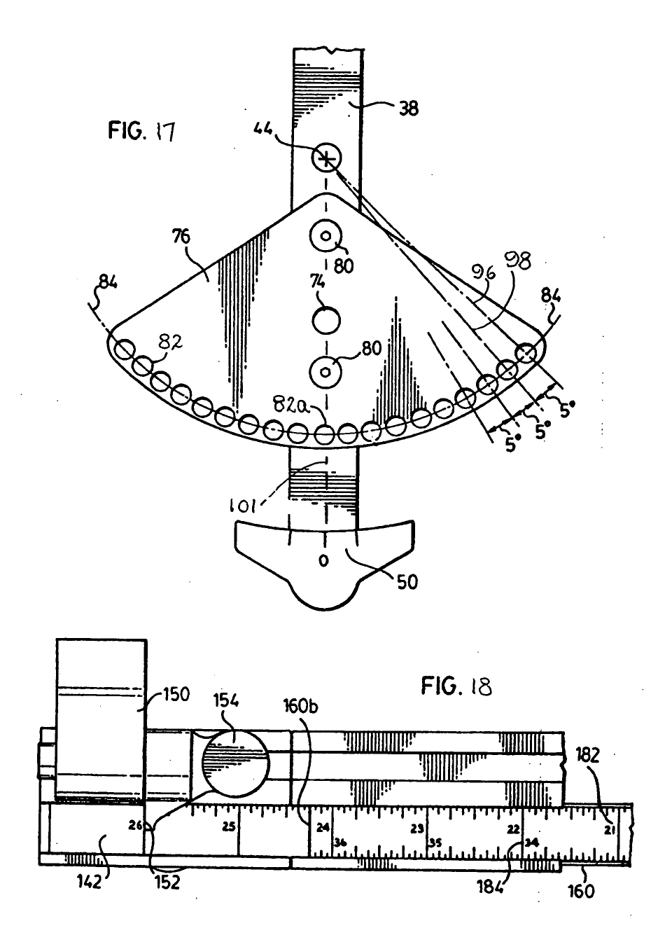

With reference to FIGS. 3 and 17, the lower plate is fixed to the guide bar 38 by screws 80 so that the plate is stationary relative to the bar. The lower plate has a number of circular apertures 82 whose centres are spaced along the arc or circumference 84-84 of a circle whose centre is on the main axis of the mitre gauge. Arc 84-84 lies on the vertically downward projection of arcs 56c-56c and 54c-54c of the upper and central plates respectively. In other words, and with reference to FIG. 3A, arcs 56a-56a, 54c-54c and 84-84 extend horizontally along the wall 85 of an imaginary cylinder having a vertically extending longitudinal axis which coincides with the main axis 44-44 of the mitre gauge.

The arrangement of the apertures in the upper, central and lower plates will now be described. With reference first to the upper plate and to FIG. 5, at the centre of the plate is a central aperture 60a and, clockwise to the right of it, a so-called “zero degree” aperture 60b is located. The angle between the latter aperture and the central aperture should be 5 degrees or a multiple thereof. That angle is between lines 86, 88, both of which run from the centres of the central and zero degree apertures, respectively, to the main axis of the mitre gauge.

Continuing further clockwise from the zero degree aperture, the next aperture 60c must be positioned such that the angle between the line 90 that extends from the centre of that aperture to the main axis and line 88 is 11 degrees. In like manner, all of the remaining apertures 60 to the right of aperture 60c must be spaced apart from the nearest apertures on both sides by an angle of 11 degrees. As well, all of the apertures 60 counterclockwise to the left of the central aperture 60a must be spaced apart from the nearest apertures by 11 degrees.

The apertures are marked as follows: the zero degree aperture 60b is marked “0”, the nearest aperture to the right of aperture 60b is marked “0.5”, the next “1” and so on. Counter-clockwise to the left of the central aperture 60a, the nearest aperture is marked “0.5”, the next “1” and so on. The central aperture is not marked.

With reference to the central plate and to FIG. 4, the first aperture 62a clockwise to the right of the central slot 64 must be axially aligned with the zero degree aperture 60b of the upper plate when the central axis 64a of the central slot is axially aligned with the centre of aperture 60a in the upper plate. Each of the remaining apertures 62 must be spaced apart from the nearest apertures by 11.5 degrees. Thus, for example, the angle between the lines 92, 94 which extends between the centres of aperture 62a, 62b, respectively, to the main axis of the mitre gauge is 11.5 degrees.

With reference to the lower plate and to FIG. 17, the angle between each of the apertures 82 is five degrees. Thus for example, the angle between lines 96, 98 which extends through the centres of two adjacent apertures and terminate at the main axis of the mitre gauge is 5 degrees. With reference to FIGS. 5, 8 and 17, an aperture 82a at the centre of the lower plate is axially aligned with central aperture 60a of the upper plate when line 86 lies on the vertically upward projection of line 101. Line 101 runs from the zero position of scale 50 to the main axis of the mitre gauge.

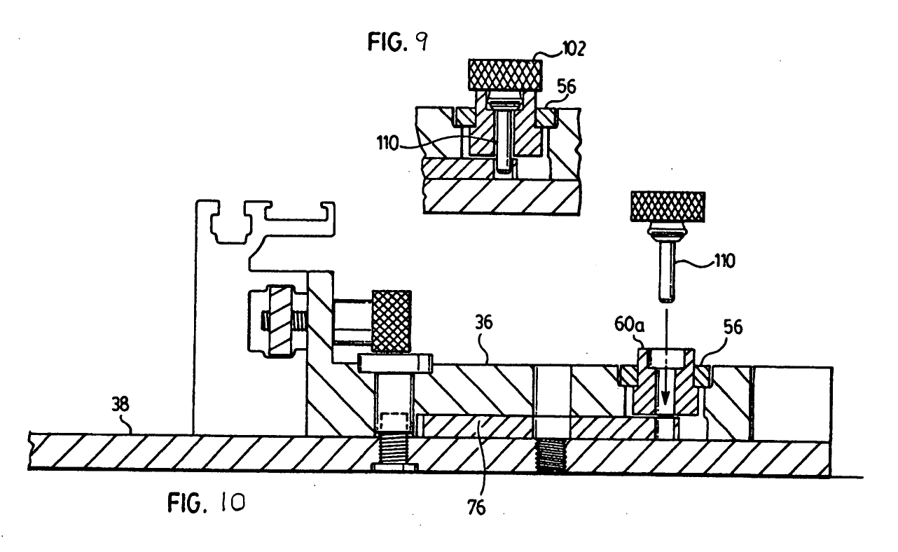

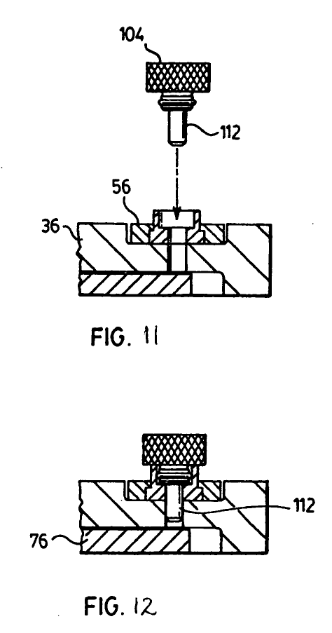

With reference to FIGS. 9 to 12, two locating pins 102, 104 are removably received in the apertures in selective plates and the pins act to prevent those plates from moving relative to the others. Pin 102 has a head of larger diameter than the head of pin 104. Henceforth, the former pin will be referred to as the “larger pin” while the latter will be referred to as the “smaller pin”.

The stem of the larger pin is longer than that of the smaller pin. With reference to FIGS. 9 and 10, the stem 110 of the larger pin extends through apertures in the upper, central and lower plates 56, 36 and 76 respectively while the stem 112 of the smaller guide pin extends through the apertures in the upper and central plates but is not long enough to extend through an aperture the lower plate 76.

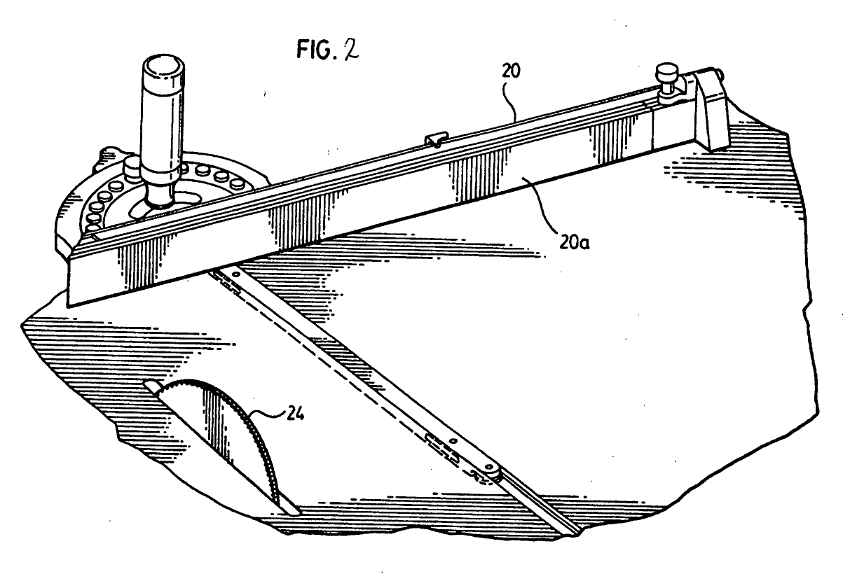

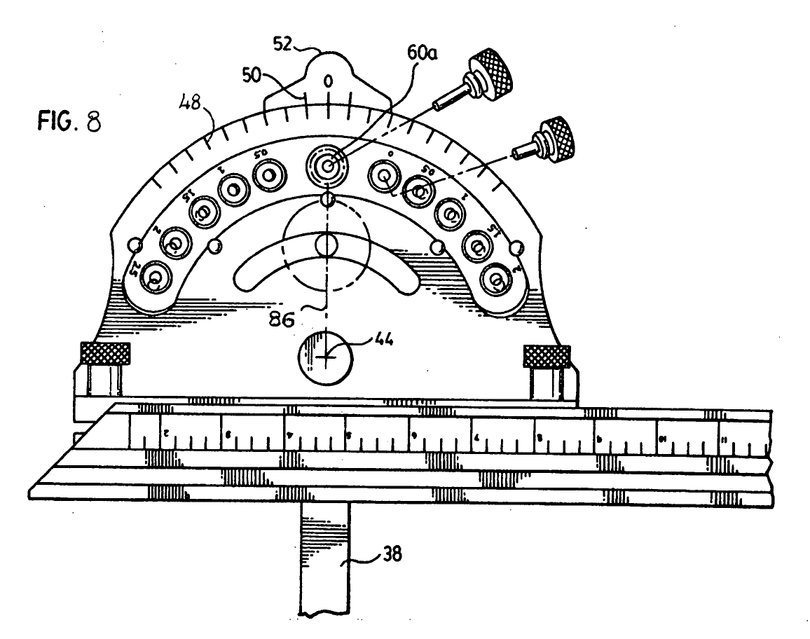

The mitre gauge can used to locate the fence so that a cut of a predetermined angle can be made in a piece of stock or work. Initially it should be noted that when the gauge is in the zero position as depicted in FIG. 8, the angle of the mitre gauge is zero. With reference to FIG. 2, front wall 20a of the fence against which the stock or work abuts is then normal to the orientation of the cut made by the saw.

The following is the procedure for making a cut of a predetermined angle in the piece of stock. It will be assumed that the angle of the cut is to be 36.5 degrees.

1. With reference to FIG. 8, the fence is slidingly received in the working surface of a table saw by means of guide bar 38 so that the lower plate of the mitre gauge is stationary. While both locating pins are removed from the gauge, the central plate is rotated relative to the stationary lower plate until the angle of the mitre gauge is a multiple of five closest to 36.5 on movable scale 48. The multiple is “35”, accordingly the central plate is rotated until the angle of the mitre gauge is 35 degrees. The stem of the larger pin is then inserted through aperture 60a on the upper plate and through an aperture in the lower plate in axial alignment with aperture 60a in order to immobilize the upper plate.

2. The smaller pin is then inserted in the aperture marked “1.5” in the upper plate and the central plate is rotated until the angle of the mitre gauge is 36.5. At that point, there will be an aperture in the central plate in axial alignment with the 1.5 aperture in the upper plate. When the smaller pin is pressed downward, the stem of the pin will enter that aperture in the central plate thereby stopping further movement of the central plate. The mitre gauge will then be immobilized and the fence will orient the stock at the correct angle.

It should be noted that the stem of the larger pin passes through axially aligned apertures in the upper and lower plates. The pin thus serves to prevent the two plates from moving relative to each other. The pin however does not prevent the central plate from moving relative to the upper and lower plates because the stem of the pin passes through slot 64 in the central plate and does not impede clockwise and counterclockwise movement of the central plate at this time. By contrast, the smaller pin passes through axially aligned apertures in the upper and central plates and serves to prevent relative movement between those plates. The stem of the smaller pin however is too short to extend into an aperture in the lower plate so that the pin does not prevent relative movement between the lower plate and the other two plates.

The apertures in the lower plate act as stop points for the upper plate and the larger pin acts as an angle-adjusting means for selecting one of those apertures or stop points to prevent relative movement between the upper and lower plates. The apertures in the upper plate act as stop points for the central plate and the smaller pin acts as an angle-adjusting means for selecting one of those apertures or stop points to prevent relative movement between the upper and central plates.

It should also be noted that the arrangement of the apertures in the various plates of the mitre gauge described above allow cuts to the nearest one half degree to be made in a piece of stock. Furthermore the arrangement of apertures requires that first, an angle which is a multiple of five be chosen and the upper plate be immobilized at that angle. Secondly, the central plate is immobilized in order to orient the fence so that the cut in the piece of stock is at the desired angle. However, should it be desired to change the arrangement of apertures so that the cuts of other orientations such as to the nearest one third degree or angles of multiples other than five, such as ten, then the apertures will be arranged differently. The angles between those apertures will reflect those differences and the angles required to achieve the desired results can be determined relatively easily by means of a computer or by means of trial and error.

### Fence

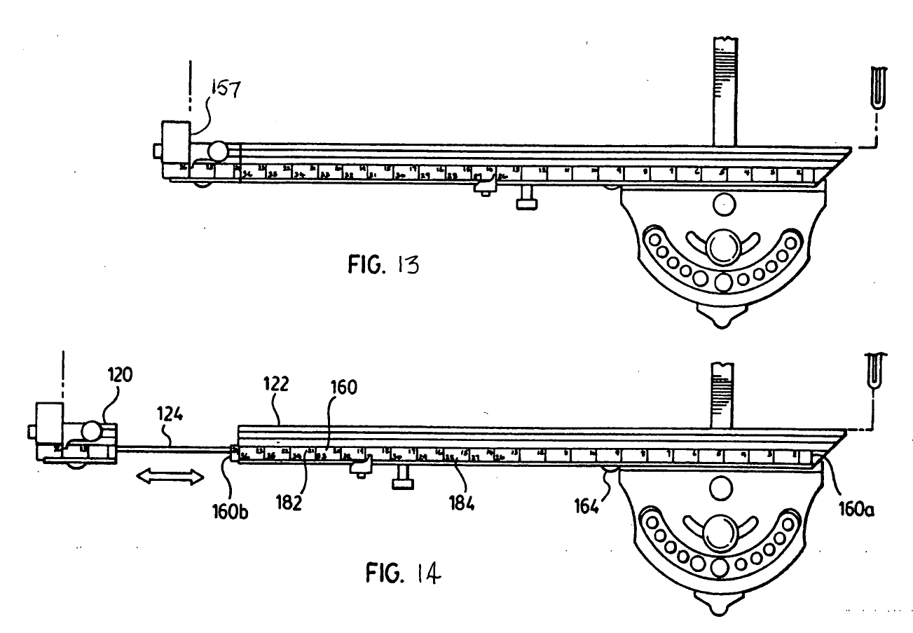

With reference to FIGS. 13 and 14 the fence of the invention is composed of two segments, a relatively short terminal segment 120 and an elongated main segment 122. The two segments are interconnected by a sliding bar 124. The bar allows the two segments to be moved apart, as illustrated in FIG. 14 and to be moved together until they abut each other, as illustrated in FIG. 13.

Each fence segment 120, 122 has the same cross-section and for the sake of brevity, only the cross-section of terminal segment 120 will be described. With reference to FIGS. 15 and 16, the terminal segment has a pair of T-slots 126, 128 formed in its upper wall. The slots are spaced apart from one another and extend longitudinally between the end walls 120a, 120b of the terminal segment. On one side wall of the terminal segment, two slots are formed, an upper slot 136 having flat upper and lower walls and a lower T-slot 138. The two slots are spaced apart from one another and extend longitudinally between the two first and second end walls of the terminal segment.

A ruler 140 (henceforth sometimes referred to as the “terminal ruler”) is received in T-slot 128 on the upper wall and is free is slide therein. The ruler has a graduated scale 142 imprinted on one of its side edges. A ruler-locking knurled knob 146 is received in the upper slot and the knob is connected to a threaded pin 148 which, when the knob is rotated, moves into and out of contact with the lower wall of the ruler thereby alternatively preventing and allowing the ruler to slide in slot 128.

The terminal segment is provided with a terminal indicator 150 having a flat forward surface 152 which ends at a pointer 152a. The position of the indicator may be adjusted by means of a knurled knob 154 mounted to a stem which is threadably received in an opening in the indicator. A nut 156 is threadably connected to the lower end of the stem and is received in slot 126. The nut secures the indicator to the terminal segment and allows it to slide along the top wall of the segment. Tightening of knob 154 prevents such sliding.

With reference to FIG. 13, the terminal indicator has a side wall 157 which lies in the same plane as forward surface 152. Side wall 157 serves as a surface against which the end wall of a piece of stock butts when the length of the stock is being measured as is explained below.

With reference to FIGS. 14, 15, 16 and 18, main segment 122 of the fence has a ruler 160 (referred to as the “main ruler”) which is slidingly received in the upper T-slot 162. The main ruler has a graduated scale which extends along each of its longitudinally extending edges. The scales are described below. The main ruler may be slid along the T-slot until knurled ruler-locking knob 164 is tightened. That knob acts in the same way as ruler-locking knob 146 to prevent the main ruler from sliding in the slot.

The main segment has an indicator 166 (referred to as the “main indicator”) having a pointer 168. The main indicator is attached to sliding bar 124 by means of a socket head screw or an Allen screw 170. The main indicator slides along the outside wall of T-slot 28.

Sliding bar 124 is received in the lower T-slot 138 of the terminal segment and the lower T-slot 28 of the main segment. The bar is bolted to a terminal retainer 172 disposed outside the lower T-slot. An Allen screw 174 attaches the retainer to the sliding bar. Tightening of the screw causes the end of the sliding bar to advance toward the retainer until both the bar and retainer frictionally engage opposite sides of the upwardly and downwardly extending outer flanges of T-slot 138. The bar is then connected to the terminal segment so that when the sliding bar moves, so too does the terminal segment. Loosening of screw 174 allows the position of the terminal segment on the sliding bar to be altered.

With reference to FIG. 16, a sliding bar retainer 176 is attached to the portion of the sliding bar in the lower T-slot 28 and it, like the terminal retainer, is outside the T-slot. The sliding bar is connected to retainer 176 by means of threaded stem 178. A knurled knob 180 is threadably connected to the stem for easy turning of the stem. Tightening of stem 178 prevents the sliding bar from sliding in the lower T-slot while loosening of the stem allows it to do so.

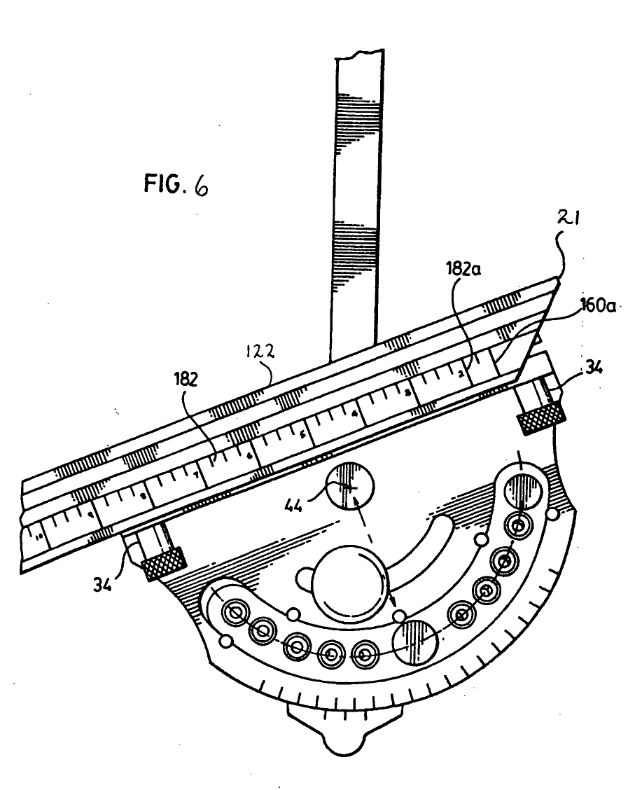

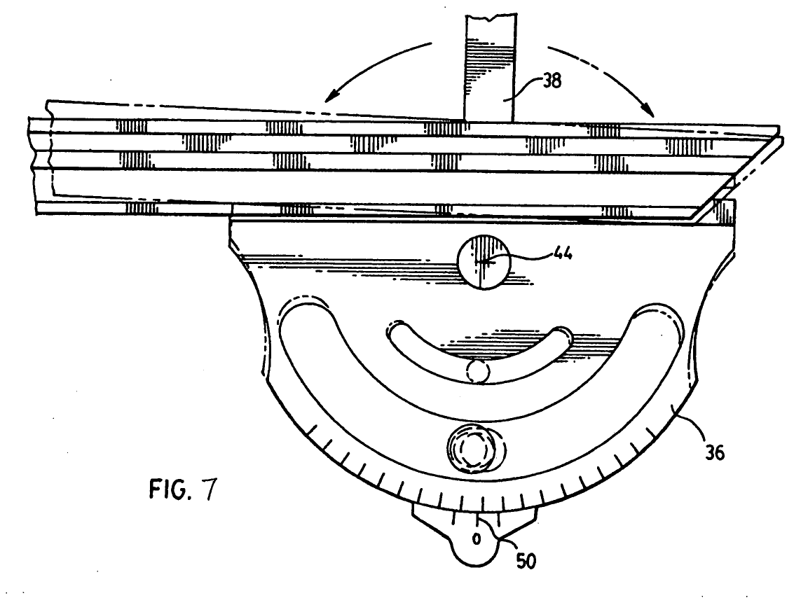

With reference to FIGS. 6, 14 & 18, the main ruler 160 has a graduated scale 182 which extends along its upper edge. There is a two inch mark 182a adjacent to the right end 160a of the ruler and increasing distances along the upper edge of the segment to the left of the two inch mark. The scale terminates at the other end wall 160b of the ruler.

When the main and terminal segments are side by side as illustrated in FIG. 18 and the main and terminal rulers abut each other, the scales on the two rulers display increasing distances from the two inch mark on scale 182. As will be observed in FIG. 18, the scale on the terminal ruler follows consecutively from that on the main ruler so that the measurement of distance from the two inch mark can be made anywhere on the two rulers.

A second graduated scale 184 extends along the lower edge of the main ruler. That scale commences at the second end wall 160b of the ruler and terminates approximately midway between its two ends. That scale is described in more detail below.

As previously indicated, provided the terminal and main rulers abut each other, the gradations on the scales on the two rulers indicate the distance between two reference positions, one two inches to the right of the two inch mark on the main ruler and the other anywhere on the scales of the fence.

Should it be necessary to measure a distance greater than 26 inches, the terminal segment can be extended to increase the effective length of the fence. When the terminal segment is extended, the distance between two reference positions, described below, is read from the second scale 184. The second scale begins with a line marked “36” and continues with lines one inch apart and marked with decreasing integers to a line marked “26” as illustrated in FIGS. 18 and 14. Those are the numbers which have been suitable where the main segment of the fence is slightly longer than about 26 inches long and the terminal segment is slightly longer than about 2 inches long.

The scales on the rulers will indicate the length of a piece of work before or after it has been cut by saw blade 24. To prepare the rulers for this purpose, the following steps must be taken:

1. With reference to FIGS. 2 and 6, knobs 34 are loosened and main fence segment 122 is advanced toward saw blade 24 until there is a slight gap between the blade and the right end 21 of the fence segment. The knobs are then tightened.

2. With reference to FIG. 15, knob 154 on the terminal indicator is loosened and the indicator is advanced toward the saw blade until the space between pointer 152 and the saw blade is 2 inches. Knob 154 is then tightened.

3. With reference to FIG. 14, main ruler-locking knob 164 is then loosened and the main ruler is advanced toward the saw blade until pointer 152 of the terminal indicator points to the 2 inch mark on scale 182 of ruler. Knob 15 is then tightened.

4. With reference to FIGS. 15 and 16, knob 180 of the sliding bar retainer is loosened and the terminal segment 120 of the fence is advanced toward the main fence segment until the two segments abut. Knob 180 is then tightened to secure the two segments together. Ruler-locking knob 146 on the terminal fence segment is then loosened to free the terminal ruler so that it can be slid into abutment with the main ruler. Knob 146 is the tightened.

5. With reference to FIG. 16, Allen screw 174 on the terminal retainer is loosened to allow the sliding bar 124 to move independently of the fence. Knob 180 is then loosened and the sliding bar along with main indicator 166 are moved until pointer 168 on the main indicator points to the 26 inch mark on the second graduated scale 184. The sliding bar is then immobilized by means of knob 180.

6. With reference to FIGS. 15 and 18, knob 154 on the terminal indicator is loosened and the indicator is slid to the left until its pointer 156 points to the 26 inch mark on terminal scale 142. Knob 154 is then tightened. The pointers of the indicators now both point to 26 inches, the pointer on the terminal indicator scale pointing to 26 on the terminal scale 142 while the pointer on the main indicator 168 pointing to 26 on the second scale 184.

The scales are now calibrated to measure a piece of stock of up to 36 inches in length after it has been cut by the table saw. To make the measurement, the piece of stock is placed such that one of its ends butts against the saw blade and its other end butts against side wall 157 (FIG. 13) of the terminal indicator. Where the piece of stock is 26 inches or less in length, loosening of knob 154 allows the terminal retainer to moved until its side wall is in the required position. Pointer 152a of the terminal indicator will then point to the length of the piece of stock, either on scale 182 of the main ruler or scale 142 of the terminal ruler.

Where the piece of stock is longer than 26 inches, knob 154 of the terminal retainer is loosened and the retainer is moved until its pointer points to the 26 inch mark on the terminal scale 142. Knob 180 of the sliding bar is then loosened to allow the terminal segment of the fence to move outwardly. The terminal retainer, being attached to the terminal fence segment, moves outwardly with the sliding bar. When the terminal retainer is far enough out that its side wall 157 butts against the end of the piece of stock, pointer 168 of the main retainer 166 will point to the length of the piece of stock on the second scale 184 on the main fence segment.

For purposes of the description which follows as well as the claims, the point on the saw blade where the 2 inch measurement is made is a so-called “first reference position” and side wall 157 on the terminal indicator is a “second reference position”.

As indicated above, the maximum distance which the scales on the main and terminal rulers can measure when they are side by side is 26 inches so that if the piece of stock is shorter than that, the two scales can be used to measure the distance without the necessity of extending the effective length of the fence. It is only where the stock is longer is that it is necessary to extend the terminal segment of the fence in the manner described before.

### Guide Bar

With reference to FIGS. 19-21, guide bar 38 is defined by lower and upper elongated surfaces 38a,b and a pair of oppositely facing side surfaces 38c,d. The bar has a protective wheel 200 which is rotatably connected to the bar at its outer end to prevent the bar from lifting out of the T-slot in the working surface of the table saw.

An elongated recess 202 is formed in side wall 38c and the recess is closed by means of a resilient cover plate 204 which is attached to the guide bar by two Allen screws 206. A cylindrical second recess 208 extends normally inwardly from the first recess 202 and a metallic ball or ball bearing 210 is accommodated in the second recess.

With reference to FIGS. 19, 22 and 23, a set screw 216 is threadably received in a cylindrical opening 218 which commences at the upper surface 38b of the guide bar and opens into the second recess 208. The set screw acts as means for adjusting the position of the ball bearing.

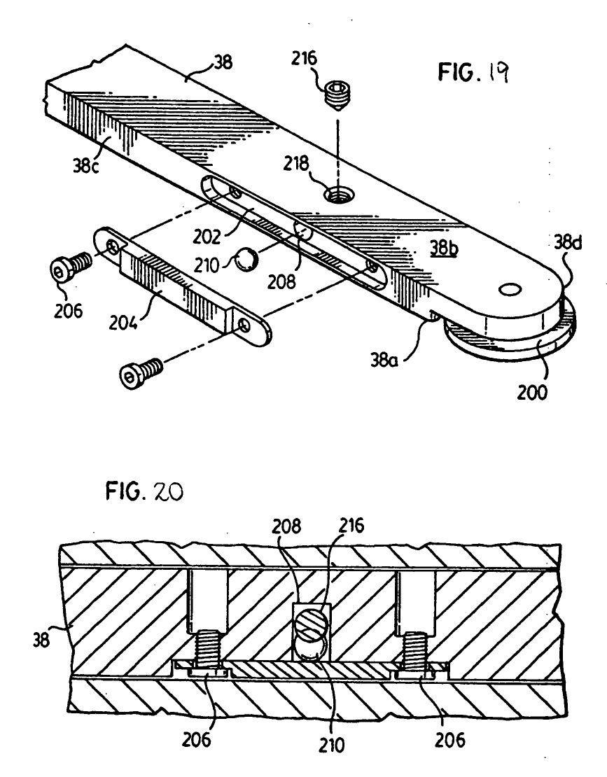

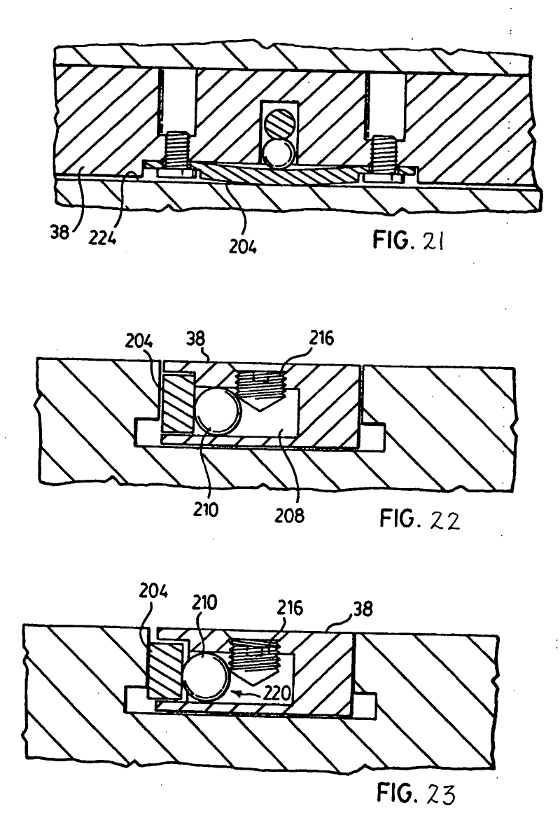

Normally the set screw and ball is as depicted in FIG. 22 but when the set screw is tightened, its lower end moves downward and into contact with the ball bearing thereby causing it to move laterally in the direction of arrow 220 from the position identified as 216 to the position identified as 210 in FIG. 20. In the latter position, the ball bearing contacts the inner surface of cover plate 204.

As illustrated in FIGS. 21 and 23, movement of the ball in this manner causes the covering plate 204 to bulge outward and into contact with the wall 224 of the groove in which the guide bar is received. Such contact will minimize any side to side movement of the bar and allow it to accurately slide along the groove.

It will be understood, of course, that modifications can be made in the structure of the mitre gauge and the fence described herein without departing from the scope and purview of the invention as defined in the appended claims.

What is claimed is:

1. A mitre gauge for adjusting the angle of a tool on a working surface including: a central element having means for moving in conjunction with said tool; a pair of angle-adjusting means, one of which causing the orientation of said central element on said working surface to be confined to a restricted range, and the other of which causing said central element to be immobilized at a single orientation within said range.

2. A mitre gauge for adjusting the angle of a tool on a working surface including: an adjusting element; a central element having means for moving in conjunction with said tool; first angle-adjusting means for selectively immobilizing said adjusting element at successive first stop points relative to said central element; and second angle-adjusting means for selectively immobilizing said adjusting element at successive second stop points relative to said working surface, said first and second stop points being arranged such that at each said second stop point, the orientation of said central element on said working surface is confined to a restricted range, and at each said first stop point, said central element is immobilized at a single orientation within said range.

3. The mitre gauge of claim 2 further including means for determining the orientation of said central element on said working surface.

4. The mitre gauge of claim 2 wherein both said central element and said adjusting element pivot about a common main axis.

5. The mitre gauge of claim 2 wherein each said element has formed therein a plurality of apertures, selective said apertures in said adjusting element being adapted to axially align with selective said apertures in said central element.

6. The mitre gauge of claim 4 wherein each said element has a plurality of spaced apertures whose centres extend along an arc which lies on an imaginary cylindrical wall having a longitudinal axis which coincides with said main axis, said apertures in each said element cooperating with those in another said element to define said first stop points.

7. The mitre gauge of claim 2 wherein said means for determining the orientation of said central element on said working surface is a pair of scales, one of which is associated with said central element and the other of which is associated with said working surface.

8. The mitre gauge of claim 2 wherein both said central element and said adjusting element pivot about a common main axis and each said element has formed therein a plurality of spaced apertures whose centres extend along an arc which lies on an imaginary cylindrical wall having a longitudinal axis which coincides with said main axis, selective said apertures in said adjusting element being adapted to axially align with selective said apertures in said central element.

9. The mitre gauge of claim 8 wherein said first angle-adjusting means is a pin having a stem of sufficient length to extend through apertures in axial alignment in said adjusting element and said central element.

10. The mitre gauge of claim 8 wherein said means for determining the angle of said central element is a pair of scales, one of which is associated with said central element and the other of which is associated with said positioning element, said scales cooperating to indicate the angle between said central element and said positioning element.

11. A mitre gauge for adjusting the orientation of a tool on a working surface including: a positioning element having means for immobilizing said element on said working surface; a central element having means for moving in conjunction with said tool and being pivotal relative to said positioning element; an adjusting element pivotal relative to said central element; first angle-adjusting means for selectively immobilizing said adjusting element at successive first stop points relative to said central element but allowing movement of both said adjusting element and said central element relative to said positioning element; second angle-adjusting means for selectively immobilizing said adjusting element at successive second stop points relative to said positioning element but allowing movement of said central element relative to both said adjusting and said positioning elements, said first and second stop points being arranged such that at each said second stop point, the angle of said central element relative to said positioning element is confined to a plurality of predetermined angles within a restricted range, and at each said first stop point, said central element is immobilized at a separate one of said predetermined angles within said range; and means for displaying the predetermined angles at which the angle of said central element is immobilized.

12. The mitre gauge of claim 11 further including means for determining the angle of said central element relative to said positioning element.

13. The mitre gauge of claim 11 wherein both said central element and said adjusting element pivot about a common main axis.

14. The mitre gauge of claim 11 wherein every said element has formed therein a plurality of apertures, selective said apertures in said adjusting element being adapted to axially align with selective said apertures in said central element, at least one of the remaining said apertures in said adjusting element being adapted to axially align with a selective one of the apertures in said positioning element.

15. The mitre gauge of claim 13 wherein every said element has a plurality of spaced apertures whose centres extend along an arc which lies on an imaginary cylindrical wall having a longitudinal axis which coincides with said main axis, said apertures in each said element cooperating with those in another said element to define said stop points.

16. The mitre gauge of claim 11 wherein said first angle-adjusting means is a pin having a stem of sufficient length to extend through apertures in axial alignment in said adjusting element and said central element but insufficient to also extend through any said apertures in said positioning element, and said second angle-adjusting element is a pin having a stem of sufficient length to extend through apertures in axial alignment in said adjusting and said positioning elements.

17. The mitre gauge of claim 11 wherein said means for determining the angle of said central element is a pair of scales, one of which is associated with said central element and the other of which is associated with said positioning element, said scales cooperating to indicate the angle between said central element and said positioning element.

18. The mitre gauge of claim 11 wherein both said central element and said adjusting element pivot about a common main axis and every said element has formed therein a plurality of spaced apertures whose centres extend along an arc which lies on an imaginary cylindrical wall having a longitudinal axis which coincides with said main axis, selective said apertures in said adjusting element being adapted to axially align with selective said apertures in said central element, at least one of the remaining said apertures in said adjusting element being adapted to axially align with a selective one of the apertures in said positioning element.

19. The mitre gauge of claim 18 wherein said first angle-adjusting means is a pin having a stem of sufficient length to extend through apertures in axial alignment in said adjusting element and said central element but insufficient to also extend through any said apertures in said positioning element, and said second angle-adjusting element is a pin having a stem of sufficient length to extend through apertures in axial alignment in said adjusting and said positioning elements.

20. The mitre gauge of claim 18 wherein said means for determining the angle of said central element is a pair of scales, one of which is associated with said central element and the other of which is associated with said positioning element, said scales cooperating to indicate the angle between said central element and said positioning element.

21. A fence for supporting a piece of stock on a working surface comprising: an elongated member having terminal and main segments, said segments adapted to move selectively apart and toward each other; a scale movable in conjunction with said main segment; an indicator movable in conjunction with said terminal segment; and a pointer movable in conjunction with said terminal segment and travelling along said scale at such time as said terminal segment moves relative to said main segment.

22. A fence for supporting a piece of stock on a working surface comprising: an elongated member having terminal and main segments, said segments adapted to move selectively apart and toward each other, a scale displayed on said main segment and the position of which on said main segment being adjustable to reflect its distance from a first reference position, an indicator movable in conjunction with said terminal segment and the position of which relative to said terminal segment being adjustable to reflect its distance from said first reference position, said indicator having a wall which defines a second reference position; a pointer movable in conjunction with said terminal segment and travelling along said scale at such time as said terminal segment moves relative to said main segment, said scale being calibrated such that the reading indicated by said pointer represent the distance between said first and second reference positions.

23. The fence of claim 22 further including additional scales on said terminal and main segments, said additional scales cooperating to indicate the distance between said first and second reference positions, said second reference position lying on one of said additional scales.

24. A guide bar for attaching a fence to a working surface, said bar being receivable in a groove which is formed in said working surface and which is defined by a lower surface and a pair of upstanding side surfaces, said bar having means for enabling said fence to pivot relative thereto and being defined by oppositely facing top and bottom walls and a pair of oppositely facing side walls each adapted to be face a separate said upstanding side surface, at least one of said side walls having a recess formed therein; a pressure bar associated with said recess; adjustment means for causing said pressure bar to move outward relative to said at least one said side wall and into contact with one said side surface.

25. The guide bar of claim 24 wherein said top wall has means for activating said adjustment means to cause said pressure bar to move outward.

26. The guide bar of claim 24 wherein said adjustment means includes; a ball disposed within said recess; and a set screw having a head to which access may be had from said top wall and a stem which extends into said recess and into contact with said ball, tightening of said set screw causing said ball to move into contact with said pressure bar with resulting outward movement thereof.
